(19) United States
(12) Patent Application Publication
(10) Pub. No.: US 2014/0057142 A1
(43) Pub. Date: Feb. 27, 2014

(54) SECONDARY BATTERY PACK FORMED BY BRIDGE CONNECTION OF TWO SECONDARY BATTERY CELLS AND TWO FUSES

(71) Applicant: ENERGY CONTROL LIMITED, Tortola (VG)

(72) Inventor: Donald P.H. WU, Hsinchu County (TW)

(73) Assignee: ENERGY CONTROL LIMITED, Tortola (VG)

(21) Appl. No.: 13/738,810

(22) Filed: Jan. 10, 2013

(30) Foreign Application Priority Data
Aug. 22, 2012 (TW) 101130380

(51) Int. Cl. H01M 2/34

(52) U.S. Cl. CPC H01M 2/34
USPC 429/61

(57) ABSTRACT

A safety secondary battery pack formed by bridge connection of two secondary battery cells and two fuses is provided with two secondary battery cells and two fuses, wherein the secondary battery cells and the fuses are connected in bridge mode, each of the positive or negative terminals of the secondary battery cells is provided with a fuse. Hence, the secondary battery pack can still work properly in the case that any single battery cell fails. When any of the secondary battery cells fails and the current flowing through the fuse exceeds the rated value, the fuse electrically connected to the failed secondary battery cell will be blown to stop current from flowing, so that the failed secondary battery cell is isolated from the rest good secondary battery cells to improve safety of the battery pack.

### BACKGROUND OF THE INVENTION

1, Field of the Invention

The present invention relates to a secondary battery pack, and more particularly to a safety secondary battery pack formed by bridge connection of two secondary battery cells and two fuses.

2. Description of the Prior Art

The existing secondary batteries are mostly provided with a great number of single secondary battery cells which are connected in series or parallel in order to have a high output capacity.

Since the single secondary battery cells are connected in series or in parallel, when any of battery cells is broken, it may lead to the failure of the whole secondary battery pack. Moreover, if the bad battery cell is not electrically isolated from other good ones, it will lead to the failure of the good battery cells or may even affect the safety of the whole battery pack.

The applicant of the present application has made a safety secondary battery pack formed by bridge connection of secondary battery cells and fuses, as shown in FIG. 1, wherein the safety secondary battery pack comprises a first secondary battery cell group 11 which consists of two series-connected secondary battery cells 111, 112 and a second secondary battery cell group 12 which consists of two series-connected secondary battery cells 121, 122. The first and second secondary battery cell groups 11, 12 are connected in parallel. Between the first and second secondary battery cell groups 11, 12 is connected a bridge wire 13, and each of the secondary battery cells 111, 112, 121 and 122 is provided with a fuse 14. When any of the secondary battery cells 111, 112, 121 and 122 is short-circuited, the corresponding fuse 14 connected to the short-circuited battery cell will be blown to isolate the short-circuited secondary battery cell from the rest good secondary battery cells.

However, the abovementioned designed is only aimed at the secondary battery pack consisting of four or more battery cells but is inapplicable to the battery pack which simply consists of two battery cells.

### SUMMARY OF THE INVENTION

The primary object of the present invention is to provide a safety secondary battery pack formed by bridge connection of secondary battery cells and fuses, wherein each of the secondary battery cells has independent fuse protection.

Another object of the present invention is to provide a safety secondary battery pack formed by bridge connection of secondary battery cells and fuses.

When any of the secondary battery cells fails and the current flowing through the fuse exceeds the rated value, the fuse electrically connected to the failed secondary battery cell will be blown to stop current from flowing, so that the failed secondary battery cell is isolated from the rest good secondary battery cells to improve safety of the battery pack.

Yet another object of the present invention is to provide a safety secondary battery pack formed by bridge connection of secondary battery cells and fuses, wherein the secondary battery pack can still work properly in the case that any single battery cell fails.

### BRIEF DESCRIPTION OF THE DRAWINGS

FIG. 1 shows a conventional safety secondary battery pack formed by bridge connection of secondary battery cells and fuses;

FIG. 2 is an illustrative view of a secondary battery pack formed by bridge connection of two secondary battery cells and two fuses in accordance with a first embodiment of the present invention;

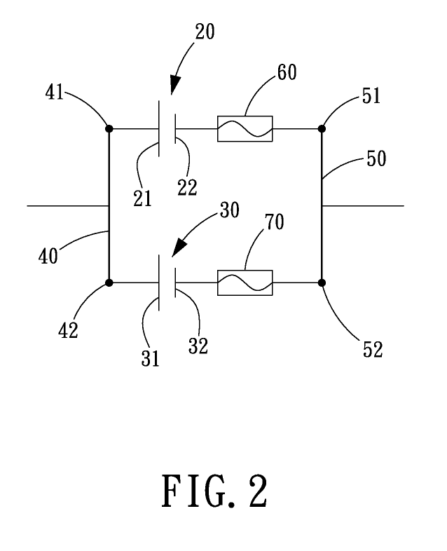

FIG. 3 is an illustrative view of a secondary battery pack formed by bridge connection of two secondary battery cells and two fuses in accordance with a second embodiment of the present invention;

FIG. 4 is an illustrative view of a secondary battery pack formed by bridge connection of two secondary battery cells and two fuses in accordance with a third embodiment of the present invention; and

FIG. 5 is an illustrative view of a secondary battery pack formed by bridge connection of two secondary battery cells and two fuses in accordance with a fourth embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

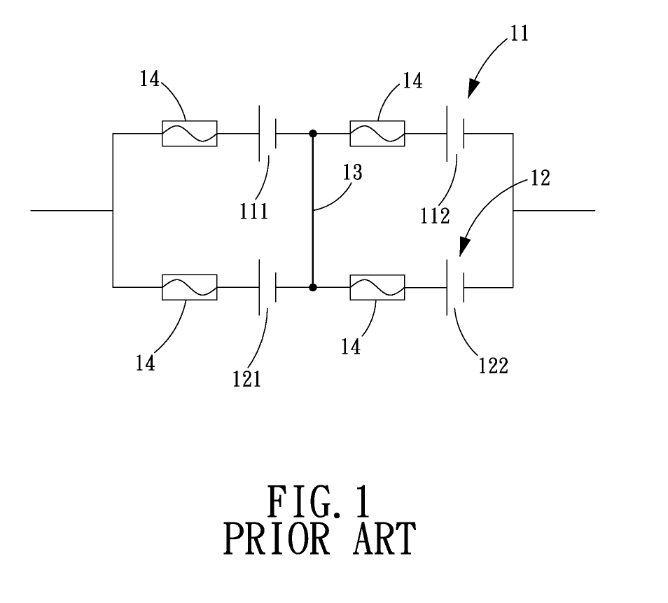

Referring to FIG. 1, a safety secondary battery pack formed by bridge connection of two secondary battery cells and two fuses in accordance with a first embodiment of the present invention comprises: a first secondary battery cell 20, a second secondary battery cell 30, a first bridge wire 40, a second bridge wire 50, a first fuse 60, and a second fuse 70.

The first secondary battery cell 20 includes a first positive terminal 21 and a first negative terminal 22.

The second secondary battery cell 30 includes a second positive terminal 31 and a second negative terminal 32.

The first bridge wire 40 is bridge-connected between the first and second secondary battery cells 20, 30 and includes a first front end 41 electrically connected to the first positive terminal 21 and a first rear end 42 electrically connected to the second positive terminal 31.

The second bridge wire 50 is bridge-connected between the first secondary battery cell 20 and the second secondary battery cell 30 and includes a second front end 51 electrically connected to the first negative terminal 22 and a second rear end 52 electrically connected to the second negative terminal 32.

The first fuse 60 is electrically connected between the first negative terminal 22 of the first secondary battery cell 20 and the second front end 51 of the second bridge wire 50.

The second fuse 70 is electrically connected between the second negative terminal 32 of the second secondary battery cell 30 and the second rear end 52 of the second bridge wire 50.

Since the first and second bridge wires 40, 50 are bridge-connected between the first secondary battery cell 20 and the second secondary battery cell 30 to form a circuit loop. When one of the first and second secondary battery cells 20, 30 fails and results in the current flowing through the fuse exceeding the rated value, the fuse electrically connected to the failed secondary battery cell will be blown to stop current from flowing, so that the failed secondary battery cell is isolated from the rest good secondary battery cells to improve safety of the battery pack.

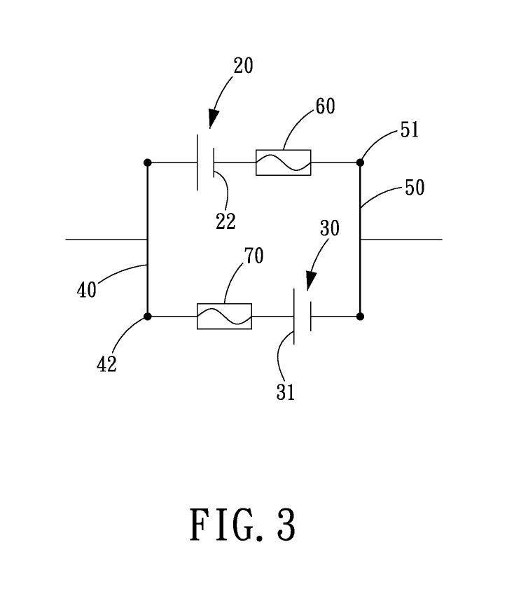

Furthermore, since the first and second bridge wires 40, 50 are bridge-connected between the first and second secondary battery cells 20, 30 to form a circuit loop, when one of the first and second secondary battery cells 20, 30 fails, another one of the secondary battery cells that doesn't fail can still work and output power. For example, when the first secondary battery cell 20 fails, the second secondary battery cell 30 is still capable of outputting power, and vice versa, when the second secondary battery cell 30 fails, the first secondary battery cell 20 is still capable of outputting power. Hence, the secondary battery pack of the present invention can still work properly in the case that any single battery cell fails. Referring to FIG. 3, a secondary battery pack in accordance with a second embodiment of the present invention is similar to the first embodiment, except that: the first fuse 60 is still electrically connected between the first negative terminal 22 of the first secondary battery cell 20 and the second front end 51 of the second bridge wire 50, and the second fuse 70 is electrically connected between the second positive terminal 31 of the second secondary battery cell 30 and the first rear end 42 of the first bridge wire 40.

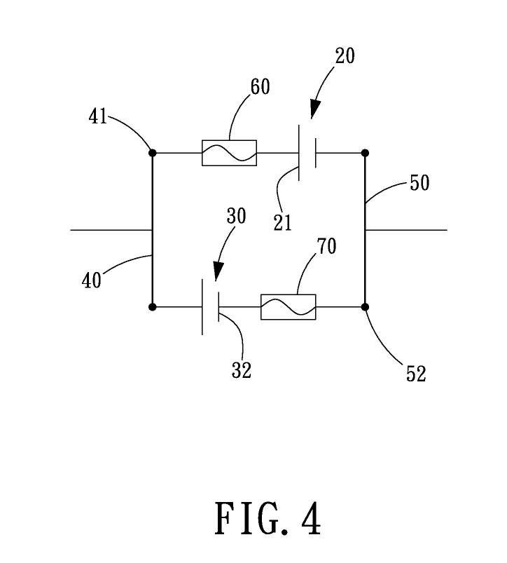

Referring to FIG. 4, a secondary battery pack in accordance with a third embodiment of the present invention is similar to the first embodiment, except that: the first fuse 60 is electrically connected between the first positive terminal 21 of the first secondary battery cell 20 and the first front end 41 of the first bridge wire 40, and the second fuse 70 is electrically connected between the second negative terminal 32 of the second secondary battery cell 30 and the second rear end 52 of the second bridge wire 50.

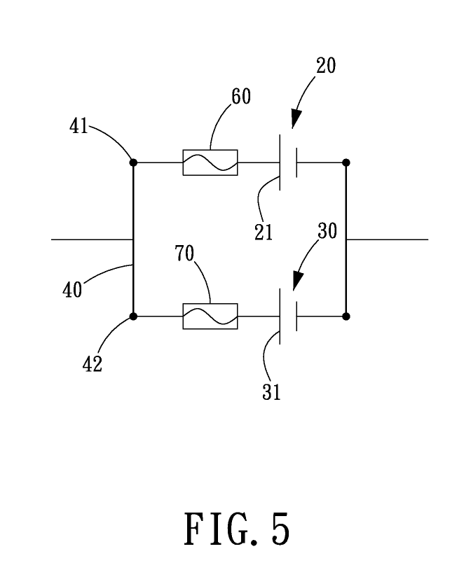

Referring to FIG. 5, a secondary battery pack in accordance with a fourth embodiment of the present invention is similar to the first embodiment, except that: the first fuse 60 is still electrically connected between the first positive terminal 21 of the first secondary battery cell 20 and the first front end 41 of the first bridge wire 40, and the second fuse 70 is electrically connected between the second positive terminal 31 of the second secondary battery cell 30 and the first rear end 42 of the first bridge wire 40.

While we have shown and described various embodiments in accordance with the present invention, it is clear to those skilled in the art that further embodiments may be made without departing from the scope of the present invention.

What is claimed is:

1. A secondary battery pack formed by bridge connection of two secondary battery cells and two fuses, comprising:
a first secondary battery cell with a first positive terminal and a first negative terminal;
a second secondary battery cell with a second positive terminal and a second negative terminal;
a first bridge wire bridge-connected between the first and second secondary battery cells and including a first front end electrically connected to the first positive terminal and a first rear end electrically connected to the second positive terminal;
a second bridge wire bridge-connected between the first secondary battery cell and the second secondary battery cell and including a second front end electrically connected to the first negative terminal and a second rear end electrically connected to the second negative terminal.
a first fuse electrically connected between the first negative terminal and the second front end or between the first positive terminal and the first front end; and
a second fuse electrically connected between the second negative terminal and the second rear end or between the second positive terminal and the first rear end.
